(19) United States
(12) Patent Application Publication
(10) Pub. No.: US 2009/0205210 A1
(43) Pub. Date: Aug. 20, 2009

(54) TWO SIDED PRUNING BLADE WITH HOOK

(76) Inventors: Richard A. Artmeier, Young Harris, GA (US); James T. McGrane, Miami, FL (US)

Correspondence Address: Fay Sharpe LLP, 1228 Euclid Avenue, 5th Floor, The Halle Building, Cleveland, OH, 44115, US

(21) Appl. No.: 12/186,822

(22) Filed: Aug. 6, 2008

Related U.S. Application Data
(60) Provisional application No. 61/028,843, filed on Feb. 14, 2008.

(51) Int. Cl. B27B 21/00

(52) U.S. Cl. 30/502

(57) ABSTRACT

A two sided pruning saw blade includes a main blade body, a concave underside cutting edge, a convex over-side cutting edge, and optionally a claw-shaped hook. The convex cutting edge is formed along a top edge of the main blade body for under-cutting a branch to form an underside kerf therein. The hook is positioned adjacent to the underside kerf to align the main blade body on a top side of the branch with the underside kerf. The concave cutting edge is formed along a bottom edge of the main blade body for over-cutting the branch to form an over-side kerf and to subsequently connect the over-side kerf with the underside kerf to sever the branch. The claw-shaped hook is disposed distally relative to the underside cutting edge to prevent the main blade body from passing wholly through the over-side kerf during cutting thereof.

This application claims the benefit of provisional patent application Ser. No. 61/028,843, filed Feb. 14, 2008, which is incorporated by reference in its entirety herein.

### BACKGROUND

The present disclosure generally relates to pruning saw blades, and more particularly relates to a two sided pruning saw blade having under and over cutting edges with a hook. In one embodiment, a two sided pruning saw blade includes a main blade body, a concave underside cutting edge formed along a bottom edge of the main blade body for over-cutting, a convex over-side cutting edge formed along a top edge of the main blade body for under-cutting, and a claw-shaped hook disposed distally relative to the underside cutting edge. The two sided pruning blade with hook of the present disclosure will be described with particular reference to this embodiment, but it is to be appreciated that it is also amenable to other like applications.

Pruning saws have been around for a long time and come in a variety of types and configurations. One known two sided pruning saw blade includes a concave upper cutting edge for creating an underside kerf on a branch (or other item to be cut) and a concave underside cutting edge for cutting through the branch or other item from a top side thereof to the underside kerf. The underside kerf limits the branch from falling under its own weight as it is cut, and instead provides a clean sawed-off break. One problem associated with this type of two sided pruning saw blade is the difficulty in creating a significant and/or visible underside kerf when using the upper cutting edge. Other problems include the absence of any feature facilitating alignment of the blade with the underside kerf for cutting the over-side kerf with the underside cutting edge. Also, over-side cutting with an underside cutting edge can be difficult because of a tendency of the blade to slip through the over-side kerf as it is being cut.

### SUMMARY

According to one aspect, an improved two sided pruning saw blade is provided. More particularly, in accordance with this aspect, the two sided pruning saw blade includes a main blade body, a concave underside cutting edge, a convex over-side cutting edge, and a claw-shaped hook. The concave underside cutting edge is formed along a bottom edge of the main blade body for over-cutting. The convex over-side cutting edge is formed along a top edge of the main blade body for under-cutting. The claw-shaped hook is disposed distally relative to the underside cutting edge.

According to another aspect, an improved pruning saw blade is provided. More particularly, in accordance with this aspect, the pruning saw blade includes a main blade body, concave cutting teeth, convex cutting teeth, and a hook. The concave cutting teeth are formed along a bottom edge of the main blade body. The convex cutting teeth are formed along an upper edge of the main blade body. The hook is disposed forwardly of the concave cutting teeth.

According to still another aspect, a method of pruning is provided for a two-sided pruning saw blade, wherein the two-sided pruning saw blade has a concave underside cutting edge formed along a bottom edge of a main blade body, a convex over-side cutting edge formed along a top edge of the main blade body, and a hook disposed distally relative to the underside cutting edge. More particularly, in accordance with this aspect, a branch is under-cut with the convex over-side cutting edge to form an underside kerf in the branch. The main blade body is then aligned on a top side of the branch with the underside kerf by positioning the hook adjacent to the underside kerf. The branch is over-cut with the concave underside cutting edge to form an over-side kerf and to subsequently connect the over-side kerf with the underside kerf to sever the branch. The hook prevents the main blade body from passing wholly through the underside kerf during cutting of the over-side kerf.

According to still yet another aspect, an improved under and over pruning saw is provided with edges that perform an under-cut of a branch, plus an over-cut. More particularly, in accordance with this aspect, a top cutting edge of the pruning saw has a convex curve that performs a positive and visible under-cut. A bottom cutting edge of the pruning saw has a concave curve that performs an over-cut of the branch. A hook at the front of the saw blade is used to position the saw blade directly over the under-cut to make a clean cut resulting in no injury to the tree, brush, or the like, being cut. Additionally, the front hook prevents the blade from slipping through the kerf and/or can be used to remove cut branches that did not fall. The convex curve cutting edge, on top of the pruning saw blade, is an improvement over conventional blades. In particular, the top cutting edge performs a positive under-cut of the branch; therefore, when the over-cut is made there is no splitting or injury to the tree, brush, or the like, being cut.

### BRIEF DESCRIPTION OF THE DRAWINGS

FIG. 1 is a side elevational view of a two sided pruning blade with a hook.

FIG. 2 is a top plan view of the two sided pruning saw blade.

FIG. 3 is front elevational view of the two sided pruning saw blade.

FIG. 4 is a schematic perspective view of a convex over-side cutting edge of the two sided pruning blade cutting an underside kerf into a branch.

FIG. 5 is a schematic perspective view of the two sided pruning blade being aligned on the top side of the branch with the underside kerf by the hook.

FIG. 6 is a schematic perspective view of a concave underside cutting edge of the two sided pruning blade cutting an over-side kerf into the branch.

FIG. 7 is a side elevational view of an alternate two sided pruning blade.

### DETAILED DESCRIPTION

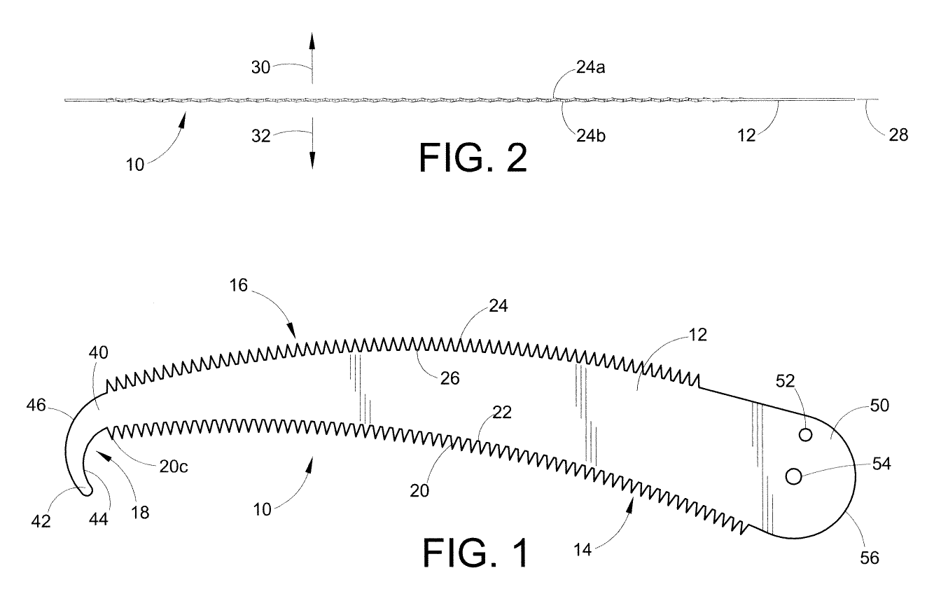

Referring now to the drawings, wherein the showings are for purposes of illustrating one or more exemplary embodiments, FIG. 1 shows a two sided pruning saw blade generally indicated by reference numeral 10. The blade 10 includes a main blade body 12 having a concave underside cutting edge 14, a convex over-side cutting edge 16, and a claw-shaped hook 18. The underside cutting edge 14, which includes a plurality of concave cutting teeth 20, is formed along a bottom edge 22 of the main blade body 12 for under-cutting. The over-side cutting edge 16, which includes a plurality of convex cutting teeth 24, is formed along a top or upper edge 26 of the main blade body 12. The hook 18 is disposed distally relative to the underside cutting edge 14 and thus forwardly of the concave cutting teeth 20.

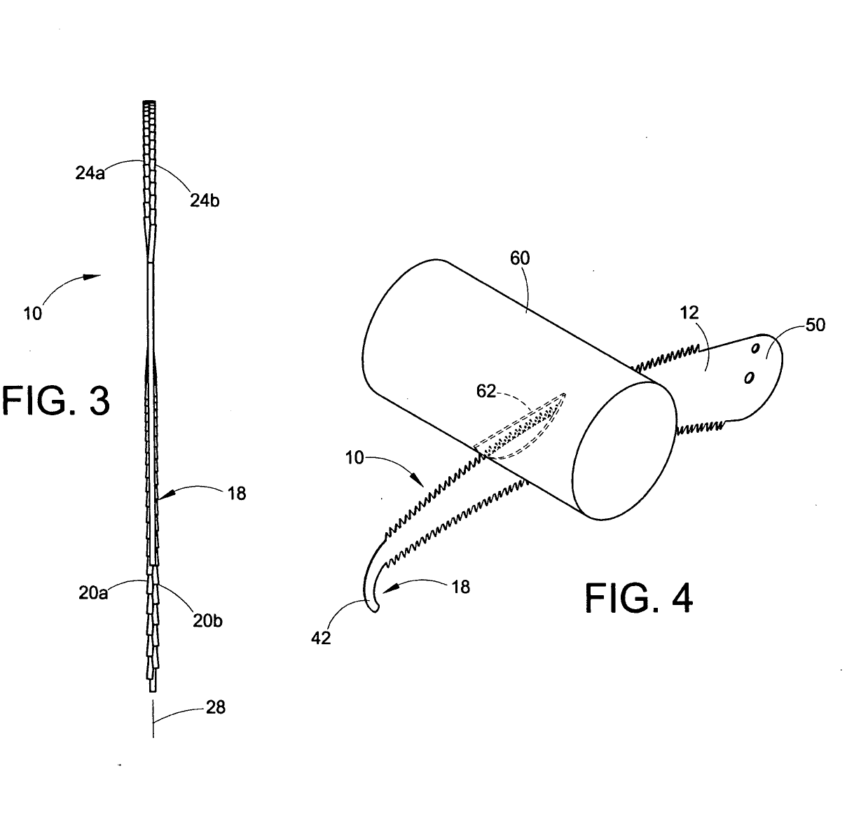

The teeth 20, 24 of the underside and over-side cutting edges can be configured to cut when the main blade body 12 is both thrust in a first direction (e.g., in the direction of the hook 18) and drawn in a second, opposite direction (e.g., in a direction away from the hook 18). More particularly, with additional reference to FIGS. 2 and 3, the teeth 20, 24 of the underside and over-side cutting edges 14, 16 can include alternating right side and left side teeth (e.g., right side teeth 20a and left side teeth 20b on concave cutting edge 20 and right side teeth 24a and left side teeth 24b on convex cutting edge 16). As shown, the right side teeth protrude to the right of the plane 28 of the main blade body 12 (i.e., in the direction of arrow 30) and the left side teeth protrude to the left of the plane 28 of the main blade body (i.e., in the direction of arrow 32). In one embodiment, the right side teeth 24a are bent or cocked such that distal portions of the teeth 24a are offset about 0.5 mm from plane 28 and, likewise, left side teeth 24b are bent or cocked such that distal parting of the teeth 24b are offset about 0.5 mm from plane 28. This advantageously creates a relatively wide kerf during cutting that reduces the tendency of the blade 12 to bind during sawing. When sawing, the right side teeth 20a,24a of the underside and over-side cutting edges 14, 16 can cut when the blade 12 is pushed and the left side teeth 20b,24b of the cutting edges 14,16 can cut when the blade 12 is pulled. In one embodiment, the blade 12 can be made of high carbon steel with filed teeth, which can be formed to cut on the push and pull of the blade. Additionally, the line of teeth on the top and bottom of the blade 12 can be of equal size and equal distance to make manufacturing easier.

The concave underside cutting edge 14 is an 81.25% concave curved cutting edge in the illustrated embodiment that is formed along a single radius of curvature. Thus, all the teeth 20 of the concave cutting edge 14 are formed along this single radius of curvature. In one exemplary embodiment, this single radius of curvature can be about 644 mm extending along an arc of about 30°. Similarly, the convex over-side cutting edge has or is formed along a single radius of curvature and, in the illustrated embodiment, is about a 75% convex curved cutting edge. Accordingly, all the teeth 24 formed along the upper edge 26 of the main blade body 12 are formed along this single radius of curvature. In one exemplary embodiment, the single radius of curvature of the convex over-side cutting edge 16 is about 572.5 mm extending along an arc of about 31°. As will be described in more detail below, the concave and convex cutting edges 14, 16, each of which is formed along a single radius of curvature, extend along the main body 12 to the hook 18. In one exemplary embodiment, the main blade body can be about 406.4 mm in length and the hook can be about 25.4 mm.

As illustrated, the hook 18 is disposed forward of a forward-most one of the convex cutting teeth 20 (i.e., forward of tooth 20c). The hook 18 diverges sharply and prominently relative to the radius of curvature of the convex cutting teeth 20 formed along the bottom edge 22 of the main blade body 12. In particular, the hook 18 includes a base 40 disposed adjacent both the concave and convex cutting teeth 20, 24 (and thus the concave and convex cutting edges 14, 16). The hook 18 further includes a distal end 42 that wraps around from the base 40 on an arc of more than 90°, and preferably more than 120°. In the illustrated embodiment, an underside 44 of the hook 18 adjacent the distal-most tooth 20c of the concave underside cutting edge 14 has a radius of curvature that is about 1/32 of the single radius of curvature of the cutting edge 14, and an over-side 46 of the hook 18 has a radius of curvature that is approximately 50% greater than the radius of curvature of the underside 44 of the hook 18.

Also, the hook 18 can extend from the bottom edge 22 of the main body 12 a greater distance than the teeth 20 of the underside cutting edge 14 extend from the main blade body 12, which advantageously allows the main body 12 to be aligned over a kerf cut by the convex over-side cutting edge 16. This can also prevent the main blade body 12 from slipping through a kerf being cut by the concave cutting teeth 20. In particular, in one embodiment, the concave cutting teeth 20 can be less than about 1Omm and the hook 18 can extend from the bottom edge 14 of the main body 12 greater than about 30 mm. If desired, the tooth 20c (or several of the teeth 20, including tooth 20c and those adjacent thereto) can have a shortened profile (i.e., extend from bottom edge 14 a lesser amount than the remaining teeth) to facilitate manufacture of the blade, though this is not required.

A base 50 of the blade 12 (i.e., a proximal end portion opposite the distally positioned hook 18) can be configured for attachment to a holding device, such as an extended pole or a handheld handle, for example. If attached to an extended pole, the pole can be a telescoping pole, if desired, to allow use of the saw blade 10 in hard to reach locations. In the illustrated embodiment, the base 50 has a pair of mounting holes 52 defined in the main blade body 12 which allow it to be attached to an extended pole or a handheld handle, for example. The base 50 also includes a curved peripheral edge 56 extending between the bottom edge 22 and the top edge 24 of the main blade body. Of course, as is to be appreciated and understood by those skilled in the art, the location, placement and number of mounting holes 52, 54, when employed, can vary depending upon the type of the holder the blade 12 is inserted into, and likewise how the blade 12 is configured to be attached to a holding device can vary (e.g., it can have some configuration other than the mounting holes 52, 54 and/or the curved peripheral edge 56).

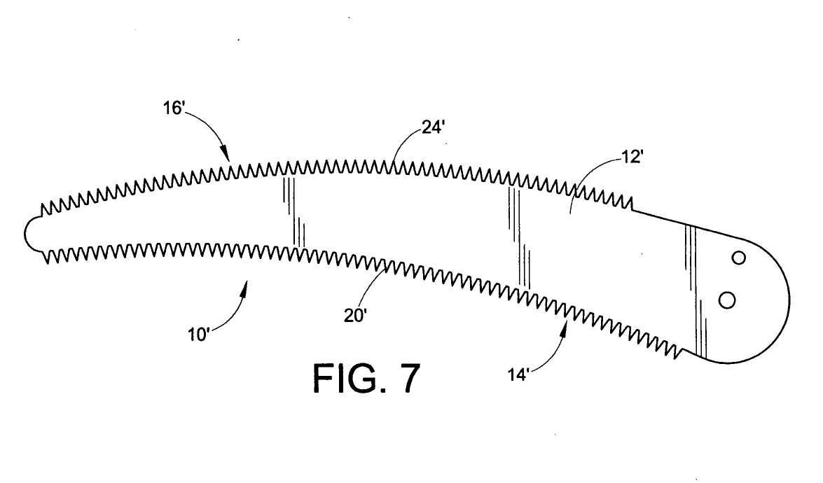

With reference to FIG. 7, an alternate two sided blade 10′ is illustrated. The blade 10′ is similar to the blade 10 of FIG. 1, but does not include a hook (e.g., hook 42). In particular, blade 10′ includes a main blade body 12′ having a concave underside cutting edge 14′ including a plurality of teeth 20′ and a convex overside cutting edge 16′ including a plurality of teeth 24′. With the exception of the hook, the blade 10′ can be the same in most respects as the blade 10 and this is not described in further detail.

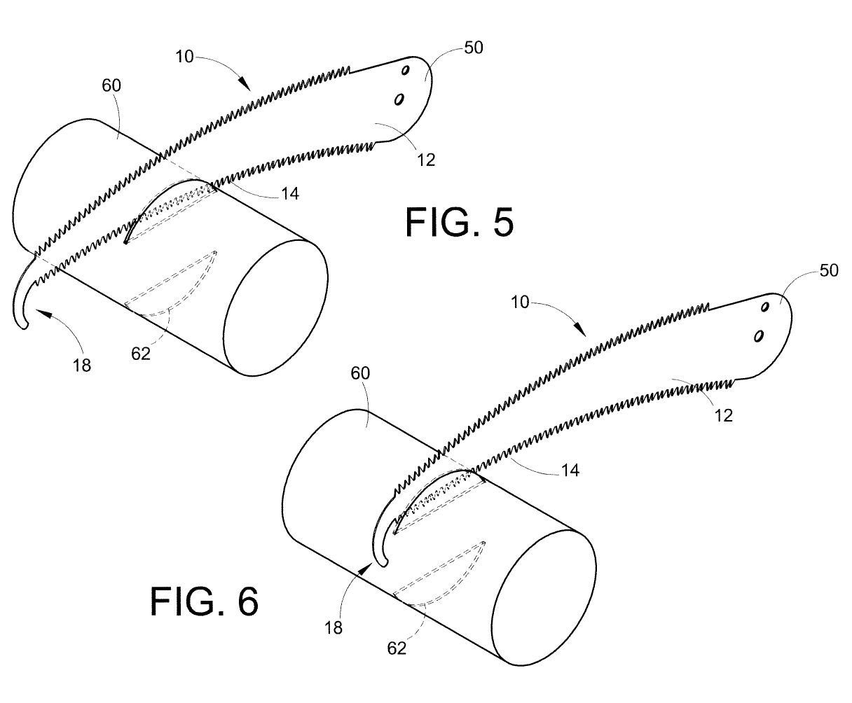

A method of pruning with the two sided pruning saw blade 10 will now be described. More particularly, with additional reference to FIG. 4, a branch, limb or the like 60 is under-cut with the convex over-side cutting edge 16 to form an underside kerf 62 in the branch 60. Due to the configuration of the teeth 24 (i.e., alternating for cutting when the blade 12 is drawn and for cutting when the blade 12 is thrust), the under-cutting can occur during pushing and pulling of the main blade body 12. The convexness of the cutting edge 14 creates a very positive under-cut (i.e., underside kerf 62) that is easily visible. Next, as shown in FIG. 5, the main blade body 12 is aligned on a top side of the branch 60 with the underside kerf 62 by positioning the hook 18 adjacent the underside kerf 62. Once aligned, with further reference to FIG. 6, the branch 60, is over-cut with the concave cutting edge 14 to form an over-side kerf 64 and to subsequently connect the over-side kerf 64 via continued sawing with the underside kerf 62 to sever the branch 60. The visible under-cut kerf 62, and its alignment relative to the hook 18, allows an operator to make a straight over-cut with the concave cutting edge 14, therefore, no splitting or injury to the branch 60. Like the over-side teeth 24, the configuration of the underside teeth 20 (i.e., alternating teeth for cutting when the blade 12 is drawn and for cutting when the blade is thrust), cutting can occur during pushing and pulling of the blade 12.

The hook 18 prevents the main blade body 12 from passing wholly through the over-side kerf 64 during cutting thereof. In particular, the hook 18 hanging over the branch 60 prevents the blade 12 from slipping through the over-side kerf 64 during cutting. The claw-shape of the hook 18 can additionally function to move severed branches, limbs and the like, such as those that fail to fall to the ground, for example. As can be seen from the foregoing, the hook 18 on the front or distal end of the main blade body 12 can perform at least one or more of the following three functions: it assists the operator to align the blade 12 over the under-cut kerf 62, it prevents the blade 12 from slipping through the over-side kerf 64 during cutting thereof, and it can be used to remove branches, such as those that fail to fall to the ground after cutting.

It will be appreciated that various of the above-disclosed and other features and functions, or alternative thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A two sided pruning saw blade, comprising:
a main blade body;
a concave underside cutting edge formed along a bottom edge of said main blade body for over cutting and a convex over-side cutting edge formed along a top edge of said main blade body for under cutting, said underside and said over-side cutting edges each include teeth configured to cut when said main blade body is thrust in a first direction and drawn in a second, opposite direction; and
a claw-shaped hook disposed distally relative to said underside cutting edge, said hook extending in a same direction as said teeth of said underside cutting edge.

2. (canceled)

3. The two sided pruning blade of claim 2 wherein said teeth of said underside and said over-side cutting edges include alternating right side and left side teeth, said right side teeth protruding to the right of a plane of said main blade body and said left side teeth protruding to the left of said plane of said main blade body.

4. The two sided pruning saw blade of claim 1 wherein said concave underside cutting edge has a single radius of curvature.

5. The two sided pruning saw blade of claim 4 wherein an underside of said hook adjacent a distal-most tooth of said concave underside cutting edge has a radius of curvature that is about 1/32 of said single radius of curvature of said concave underside cutting edge.

6. The two sided pruning saw blade of claim 5 wherein said single radius of curvature of said concave underside cutting edge is about 640 mm extending along an arc of about 30°.

7. The two sided pruning saw blade of claim 1 wherein said concave and said convex cutting edges extend along said main body to said hook.

8. The two sided pruning saw blade of claim 7 wherein an over-side of said hook has a radius of curvature that is approximately fifty percent greater than a radius of curvature of an underside of said hook.

9. The two sided pruning saw blade of claim 1 wherein said hook extends from said bottom edge of said main body a greater distance than teeth of said underside cutting edge extend from said main blade body to align said main blade body over a kerf cut by said convex over-side cutting edge.

10. A pruning saw blade, comprising:
a main blade body;
concave cutting teeth formed along a bottom edge of said main blade body;
convex cutting teeth formed along an upper edge of said main blade body; and
a hook disposed forwardly of said concave cutting teeth, said bottom edge of said main blade body forming a curved concave underside of said hook forward of said concave cutting teeth that engages an associated branch when said hook is used to grab the branch.

11. The pruning saw blade of claim 10 wherein said concave cutting teeth include first cutting edges that cut when said blade is pushed and second cutting edges that cut when said blade is pulled.

12. The pruning saw blade of claim 10 wherein said convex cutting teeth include first cutting edges that cut when said blade is pushed and second cutting edges that cut when said blade is pulled.

13. The pruning saw blade of claim 10 wherein said hook is disposed forward of a forward-most one of said convex cutting teeth and wherein said hook is claw-shaped.

14. The pruning saw blade of claim 10 wherein said hook diverges sharply and prominently relative to a radius of curvature of said concave cutting teeth formed along said bottom edge of said main blade body.

15. The pruning saw blade of claim 14 wherein said hook includes a base disposed adjacent both said concave and said convex cutting teeth and a distal end wrapping around from said base on an arc of more than 90°.

16. The pruning saw blade of claim 15 wherein said distal end of said hook wraps around from said base on an arc of more than 120°.

17. The pruning saw blade of claim 10 wherein all teeth formed along said bottom edge of said main blade body are formed along a single radius of curvature and all teeth formed along said upper edge of said main blade body are formed along a single radius of curvature.

18. The pruning saw blade of claim 10 wherein said concave cutting teeth are less than about 10 mm and said hook extends from said bottom edge of said main body greater than about 30 mm to prevent said main blade body from slipping through a kerf when cutting with said concave cutting teeth.

19. (canceled)

20. (canceled)

21. (canceled)

22. A two sided pruning saw blade, comprising:
a main blade body;
a concave underside cutting edge formed along a bottom edge of said main blade body for over cutting and a convex over-side cutting edge formed along a top edge of said main blade body for under cutting, said underside and said over-side cutting edges each include teeth configured to cut when said main blade body is thrust in a first direction and drawn in a second, opposite direction, said teeth including alternating right side and left side teeth, said right side teeth protruding to the right of a plane of said main blade body and said left side teeth protruding to the left of said plane of said main blade body; and
a claw-shaped hook disposed distally relative to said underside cutting edge, said hook extending in a same direction as said length of said underside cutting edge,
wherein said concave underside cutting edge has a single radius of curvature that is about 640 mm extending along an arc of about 30°, and wherein said teeth of said concave underside cutting edge are less than about 10 mm and said hook extends from said bottom edge of said main body greater than about 30 mm to prevent said main blade body from slipping through a kerf when cutting with said concave cutting teeth.
